(19) United States
(12) Patent Application Publication
(10) Pub. No.: US 2013/0226944 A1
(43) Pub. Date: Aug. 29, 2013

(54) FORMAT INDEPENDENT DATA TRANSFORMATION

(71) Applicants: Sushil Baid, Hyderabad (IN); Kranthi K. Mannem, Hyderabad (IN); Palavalli R. Sharath, Hyderabad (IN); Anil K. Prasad, Hyderabad (IN); Siddharth Sharma, Hyderabad (IN); Krishnan Srinivasan, Hyderabad (IN)

(72) Inventors: Sushil Baid, Hyderabad (IN); Kranthi K. Mannem, Hyderabad (IN); Palavalli R. Sharath, Hyderabad (IN); Anil K. Prasad, Hyderabad (IN); Siddharth Sharma, Hyderabad (IN); Krishnan Srinivasan, Hyderabad (IN)

(73) Assignee: Microsoft Corporation, Redmond, WA (US)

(21) Appl. No.: 13/404,282

(22) Filed: Feb. 24, 2012

(51) Int. Cl. G06F 17/30

(52) U.S. Cl. 707/756; 707/E17.006

(57) ABSTRACT

Data transformation can be performed across various data structures and formats. Moreover, data transformation can be format agnostic. Output data of a second structure can be generated as a function of input data of a first structure and a transform independent of the format of input and output data. In one instance, the transform can be specified by way of a graphical representation and encoded in a form independent of input and output data formats. Subsequently, data transformation can be performed as a function of the transform and input data.

### BACKGROUND

Data transformation involves transforming data from a first structure into data of a second structure. Data transformation is performed based on a map that relates data elements from an input or source structure to an output or target structure and captures any requisite transformations. Code can be generated from the data map that converts data from a source structure to a target structure. For example, code can be generated that transforms a source structure that specifies a person with two fields, such as first name and last name, to an target structure that utilizes a single name field, by concatenating a first name and a last name from the source and supplying the resultant single field to the target.

One significant data transformation technology is XSLT (eXtensible Style sheet Language Transformation). XSLT is a transformation language used to transform XML (eXtensible Markup Language) documents. An XSLT processor takes as input a source XML document and an XSLT style sheet and produces a new target XML document with a different schema. The XSLT style sheet, which can be specified by hand, includes a collection of template rules that guide the production of a target XML document.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to format independent data transformation. An individual can author a transform, or map, of input data to output data in terms of structure and without regard to format. A mechanism is provided to facilitate transform specification, for instance through use of a graphical user interface. Further, maplets, which capture repeatable transformations, can be saved and re-used to aid transform specification. The transform can be encoded in a form that is independent of any input or output format. Subsequently, data transformation can be performed as a function of the transform and input data. For example, the transform can be used to generate executable code that performs data transformation upon execution. Access to input data and population of output data of specific formats can be enabled through implementation of one or more common interfaces.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data transformation system.

FIG. 2 is a block diagram of a representative author component.

FIG. 3 is a block diagram of a user interface component.

FIG. 4 depicts an exemplary graphical user interface.

FIG. 5 illustrates sample input and output data structures.

FIG. 6 depicts a set of interfaces that facilitate format independent data transformation.

FIG. 7 is a flow chart diagram of a method of data transformation.

FIG. 8 is a flow chart diagram of a method of data transformation.

FIG. 9 is a schematic block diagram illustrating a suitable operating environment for aspects of the subject disclosure.

### DETAILED DESCRIPTION

Data transformation conventionally concerns bridging mismatches in data schemas, or structures. In addition to variations in structure, various data formats can be encountered in the data transformation domain, such as where multiple software systems are employed that were not designed to communicate with each other. By way of example, a mashup application could obtain data in different formats from different web services including an XML (eXtensible Markup Language) document, a JSON (JavaScript Object Notation) object, and a CLR (Common Language Runtime) object. Specialized code is written by programmers to enable desired communication with diverse systems. In particular, code is authored to normalized input data to a specific format, typically XML. In the above example, the JSON object and the CLR object can be converted in their entirety to XML. Next, data transformation can be performed using XSLT over XML documents. Additional code can subsequently be utilized to convert a produced XML document to a desired format. In addition to requiring programming experience, the above approach incurs significant overhead with respect to converting input data completely from its original format to a specific format, here XML, and converting from the specific format to a desired output format.

Details below are generally directed toward format independent data transformation. Stated differently, data transformation can be employed with respect to arbitrary input and output data formats as well as differing structure. A mechanism, such as a graphical user interface, can be provided to facilitate specification of transform, which maps input data of a first structure to output data of a second structure without regard to format. Additionally, maplets, which capture repeatable transformations, can be saved and reused to aid authoring transforms. The transforms can be encoded in a form independent of input and output data formats. Data transformation can subsequently be performed as a function of at least the transform and the input data. In one instance, one or more common interfaces can be employed that abstract away details of input and output data formats. In other words, a universal data transformation system is disclosed that can take in any data format and output any data format.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

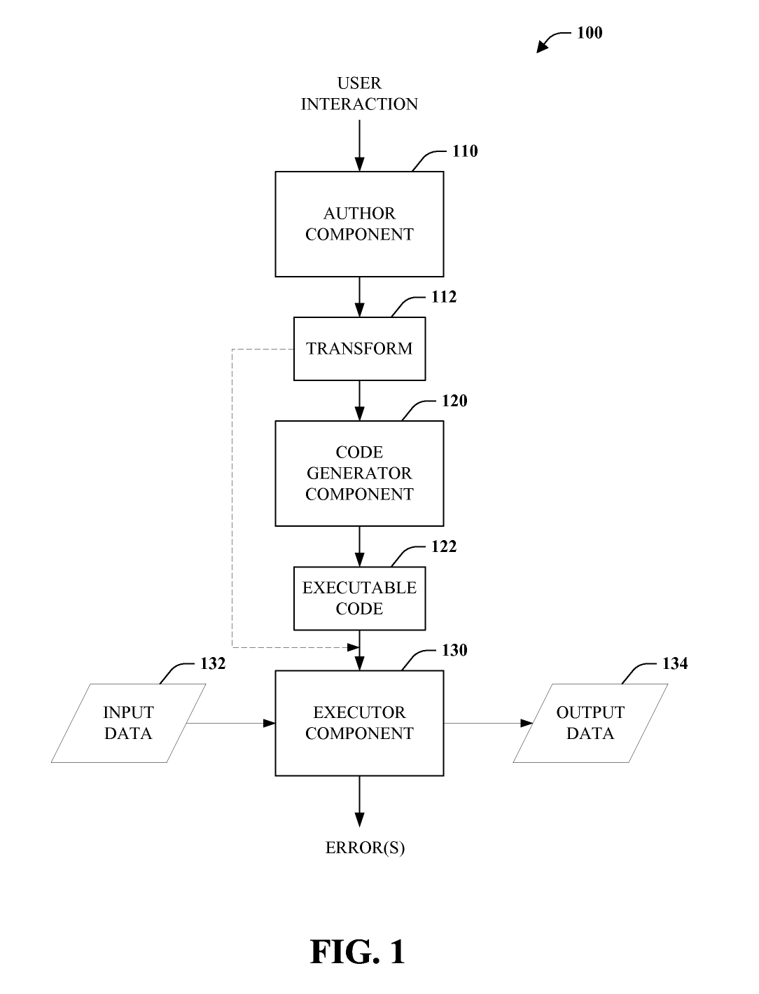

Referring initially to FIG. 1, a data transformation system 100 is illustrated. The data transformation system 100 includes author component 110 configured to facilitate provisioning of a map, or transform as a function of user interaction. As will be described further below, in one instance the author component 110 can employ a graphical user interface that allows specification of a transform graphically, or in other words in terms of graphical representation. A transform refers to a mapping of input data to output data both of arbitrary structure and format. Structure concerns the schema or organization of data, and format pertains to a serialization format such as, but not limited to, an XML document, a JSON object, a CLR object, or EDI (Electronic Data Interchange) message. The author component 110 can produce transform 112 that expresses transformation of structures in a form, or representation, that is independent of input data and output data formats utilized. In other words, the transform is encoded in an internal representation that is format agnostic. For example, the transform 112 can be encoded in an intermediate language (IL), as will be described further later herein.

Code generator component 120 is configured to generate executable code 122 from the transform 112. In one instance, the code generator component 120 can form part of a compiler (not shown) that parses the transform, performs syntactic and sematic analysis, and generates computer executable code. In one particular scenario, the code generator component 120 can form part of just-in-time (JIT) compiler or the like. Alternatively, it is also possible and contemplated that such code generation can be avoided where the produced transform 112 can be interpreted rather than compiled. This scenario is depicted with a dashed arrow associated with the transform 112.

Executor component 130 is configured to execute executable code 122, or indirectly execute, or interpret, transform 112. Upon execution, input data 132 can be transformed to output data 134. More specifically, input data of a first structure is transformed to output data of a second structure, where the first and second structures are different. Further, since transformation typically does not alter the input data 132, it can be said that the executor component 130 generates, or produces, the output data 134 as a function of the input data 132 and transform 112 that maps the input data 132 to the output data 134. As will be described further below, the executor component 130 can perform structural data transformation with much regard for format. For example, the executable code 122 can rely on a common object system, or the like, to perform transformation in a format agnostic manner. In other words, the executable code 122 assumes that it can deal with data of any format in the same way. This can be accomplished by wrapping access to data operated on by the code through the same interface or set of interfaces. Such an interface or set interfaces can provide a normalized view of data. The executor component 130 can also output one or more error messages, for instance if the data transformation cannot be completed for some reason.

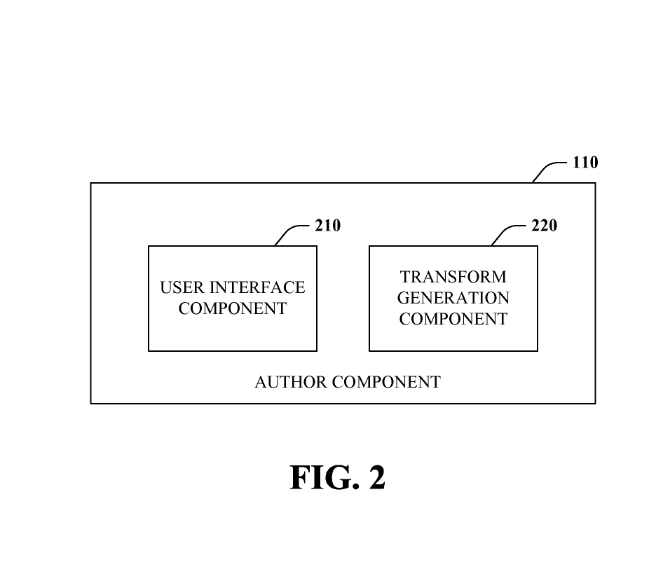

FIG. 2 depicts a representative author component 110 in further detail. As previously described the author component 110 is configured to facilitate provisioning of a transform, or map. The author component 110 can afford such functionality by way of user interface component 210 and transform generation component 220. The user interface component 210 is configured to acquire user input. In one embodiment, the user interface component 210 can be a graphical user interface that accepts input by way of graphic interaction such as by mouse clicks and drags with respect to graphic objects. Additionally or alternatively, the user interface component 210 can accept input as text or a series of one or more computer executable instructions authored in a computer programming language.

Users of a data transformation system are typically not skilled computer programmers. Thus, such users will appreciate a user-friendly interaction mechanism, for example clicking and dragging with respect to graphic representations. However, for users that are skilled programmers, the author component 110 can expose an interface that allows coding a transform from scratch or supplementing other interaction mechanisms. In one instance, coding can be performed with respect to an underlying transformation programming language. Additionally or alternatively, the user interface component 210 can expose and accept a declarative manner of specifying transforms. For example, a declarative programming language can be employed and subsequently utilized to generated underlying code supported by the data transformation system.

The transform generation component 220 is configured to generate the transform 112 of FIG. 1, based on, or as a function of, user input specified in one or more manners employing the user interface component 210. The transform generation component 220 can produce the transforms 112 in a variety of forms. In one instance, an abstract syntax tree can be produced. For example, the abstract syntax tree (AST) can be generated based on a graphical user representation of a transform. The code generator component 120 can accept the abstract syntax tree as input, perform semantic analysis, and output the executable code 122. Alternatively, the transform 112 can be in a form that is interpretable and can thus bypass subsequent code generation based thereon.

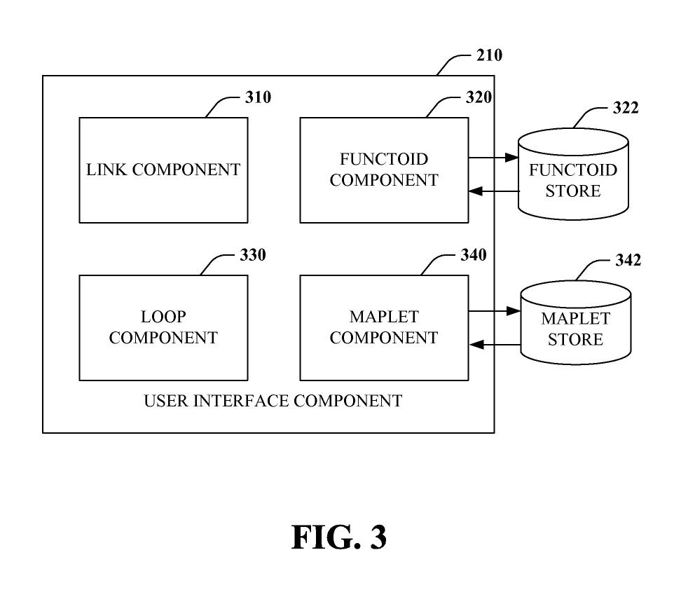

The user interface component 210 can expose functionality supported by an underlying transformation language and runtime of the data transformation system 100. FIG. 3 illustrates in block diagram form a subset of the functionality that can be accessed by way of the user interface component 210. Link component 310 is configured to enable a user to specify a link of one or more portions of an input data structure to one or more portions of an output data structure. For example, an employee in an input data structure can be linked to a person in an output data structure.

Functoid component 320 is configured to enable use of functions or methods over data. Functions or methods, also referred to as functoids, can be defined and stored in functoid store 322. Subsequently, previously defined functoids (including user—defined and out-of-box functoids) can be employed to facilitate specification of data transformation. A functoid can take a number of values as input and produce a value as output, wherein input values are integers or strings, for instance. By way of example, a functoid can be defined and utilized to concatenate data from two or more data fields. For instance, a first name and a last name can be concatenated to produce a full name. However, functoids can be arbitrarily complex in a manner that exploits supported functionality.

Loop component 330 can be employed to specify transformations over input data collections. More specifically, one or more repeating nodes of an input data structure can be linked to a single repeating node in the output data structure. For example, consider a company with many departments where each department has many employees. In this instance, looping can be employed to specify a particular transform for each employee of each department. Looping can also be conditional and nested, among other things.

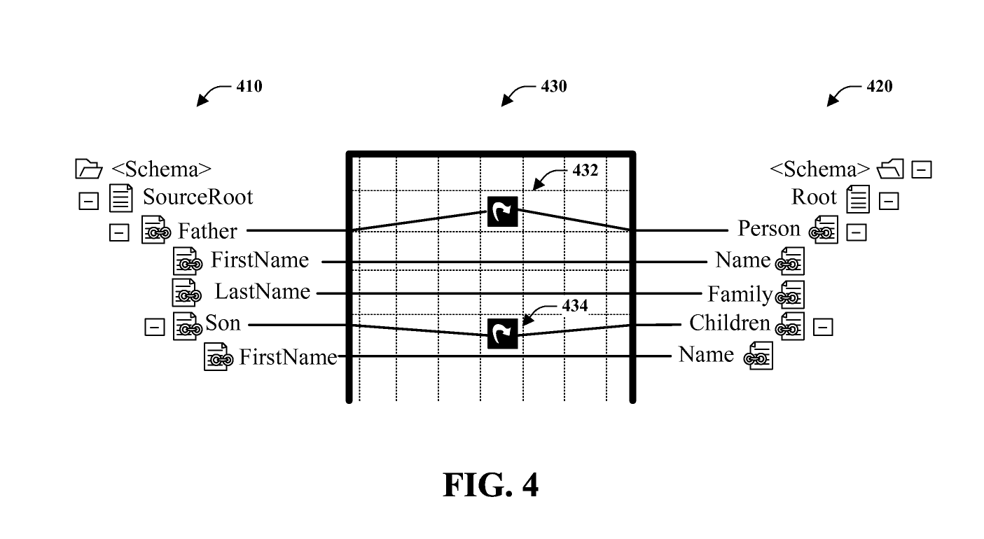

Referring briefly to FIG. 4, an exemplary graphical user interface that can be provided by the user interface component 210 is illustrated. On the left side, an input data structure 410 is illustrated in a tree structure. On the right side, an output data structure 420 is also shown as a tree. Between the input data structure 410 and output data structure 420 is a mapping area 430. With the mapping area 430, users can utilize gestures such as drag and click, among others, to draw lines between portions of the input data structure and the output data structure thereby specifying a link. Here, “FirstName” is linked to “Name” and “LastName” is linked to “Family.” Similarly, functoids or loops can be inserted in the mapping area 430. As shown, there is a first loop 432 and a second loop 434 nested within the first loop 432. In other words, a loop is specified within a loop. Here, this indicates for each “Father” record a person record is expected and for each “Son” record inside a “Father” record, a “children” record is expected.

Returning to FIG. 3, the user interface component 210 can also include support for maplet component 340. A maplet can correspond to a subset of a transform, or a small map, between input data and output data that can be reused. There is often repetition in data transformation. For example, the structure of input data might be an employee with a first name, last name, and the structure of the output data as a single employee name as the output data. Since this is common, rather than dragging and dropping every time a first name and last name are concatenated to create a full name, a maplet can be created and reused. The maplet component 340 is configured to enable creating and saving a maplet in maplet store 342 as well as provisioning created maplets for use. For instance, if a user believes that a transform is repeatable, they can save the transform as a maplet. When authoring a transform, available maplets can be discoverable by way of search. Additionally or alternatively, the maplets can be automatically suggested to a user based on context including, for example, input and output data structures, among other things. If a user selects a maplet, the maplet can automatically be linked to existing structures and otherwise deployed as if the transformation had been authored by hand.

In accordance with one embodiment, the subject data-transformation system 100 can employ intermediate language (IL) as an underlying transformation programming language to express transformation of structures. What follows is a description of concepts of such an intermediate programming language as well as pseudo code. Additionally, a common, format-agnostic object system is described that can be employed by the IL. This description is meant to aid clarity and understanding with respect to aspects of the disclosed subject matter and not to limit the scope of the appended claims.

Further, the description utilizes the term “object” as it relates to input and output data. Various data formats utilize different terms to describe a collection of structured data including object, document, and message, among other things. It is not intended that aspects of this disclosure be limited to objects but rather can related to any input and output data regardless of whether the format is termed an object, a document, a message, or something else.

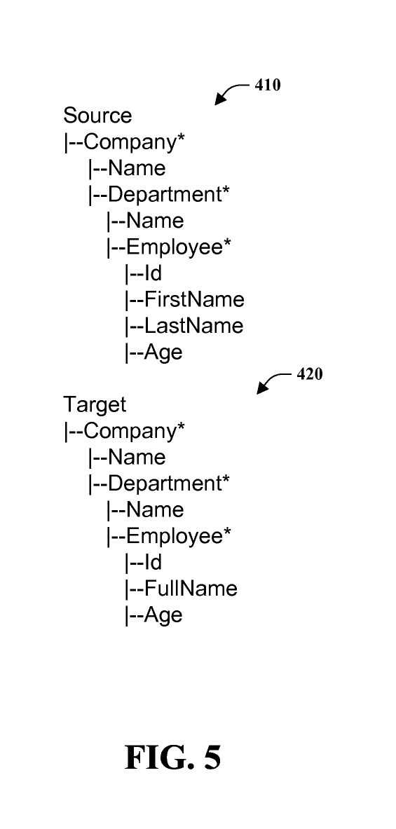

Consider the exemplary input data structure 410 (a.k.a. source) and output data structure 420 (a.k.a. target) provided in FIG. 5. In the notation, a “*” appended at the end of a node name implies that the node represents a collection (or repeating node in XML parlance). A transform from input data to output data can be expressed by way of the following IL pseudo code:

```
Transform($source, $target)
{
  MapEach($srcCompany in $source/Company to $tgtCompany in
  $target/Company)
  {
  $tgtCompany/Name = $srcCompany/Name
  MapEach($srcDept in srcCompany/Department to $tgtDept in
$tgtCompany/Department)
  {
    $tgtDept/Name = $srcDept/Name
    MapEach($srcEmp in $srcDept/Employee to $tgtEmp in $tgtDept/
    Employee)
    {
    var $fullName = StringConcat($srcEmp/LastName, “, ”,
    $srcEmp/FirstName)
    $tgtEmp/Id = $srcEmp/Id
    $tgtEmp/FullName = $fullName
    }
  }
  }
}
```

The input and output data participating in the transform, “source” and “target” in the above snippet, can be represented through named values in the IL. A named value is a value that can be referred to using a name. Any intermediate data, like “fullname” in the above snippet, that is computed in order to perform a transformation can also be represented through a named value. Input and output data participating in the transform can be treated the same way by the IL regardless of structure or format. In order to express data access, whether it is for retrieving data from input or populating data into output, the IL can rely on a path construct. In the above snippet, strings containing “/” characters, like “source/Company” and “tgtEmp/FullName,” are path expressions.

The IL used to express transforms includes constructs that fall into two categories: initialization constructs and map statements. Initialization constructs perform the task of binding a name to a value. The line “var fullName= . . . ” shown the above code sample is an example of an initialization construct. There are two kinds of initialization constructs. Variable initialization is one kind that provides the ability to bind a value produced by a “MapExpression” (as explained below) to a name. List initialization is another kind that provides the ability to bind a list of values generated by a block of intermediate language code to a name.

The map statement category includes the following constructs:
Assignment—Provides assignment of a value from a source “MapExpression” to a target path.
Block—Encapsulates a collection of Initializations and a collection of MapStatements.
MapEach—Provides the ability to process a collection of source objects and produce a collection target objects by performing a specified transformation for each of the source objects.
ForEach—Provides the ability to repeat the execution of a Block, for each item in a given source collection.
IfThen—Provides the ability to conditionally execute a MapStatement.
AddItemToList—Provides the ability to add an item to a list.
   The below code snippet demonstrates how “foreach” and “ifthen” can be used in addition to other concepts demonstrated by the previous snippet.

```
Transform($source, $target)
{
  MapEach($srcCompany in $source/Company to $tgtCompany in
  $target/Company)
  {
  $tgtCompany/Name = $srcCompany/Name
  ForEach($srcDept in $srcCompany/Department)
  {
    MapEach($srcEmp in $srcDept/Employee to $tgtEmp in $tgtDept/
    Employee)
    {
    var $fullName = StringConcat($srcEmp/LastName, “, ”,
    $srcEmp/FirstName)
    $tgtEmp/Id = $srcEmp/Id
    $tgtEmp/FullName = $fullName
    $tgtEmp/DeptName = $srcDept/Name
    if ($srcDept/Name == “Research”)
    {
      $tgtEmp/ResearchArea = $srcEmp/ResearchArea
    }
  }
  }
}
```

Here, mapping is performed for each company department. Further, if the department is research then the mapping also includes a research area.

“MapExpressions” provide the ability to represent the computation of a value in the IL. They can represent constant values, function invocations, or textual expressions. The following kinds of map expression are defined:
ConstantExpression—Represents a single constant value or a list of constant values.
PathExpression—Represents a path access on a named value via path strings described earlier.
FunctionInvocationExpression—Represents invocation of built-in functions with a list of other MapExpressions as arguments.
TextBasedExpression—Represents a textual expression that the user can write in a syntax similar to that of C#® to compute a value.
LambdaExpression—Represents an argument list and a textual expression that can be used as a selector or a predicate function (or a generic function to be evaluated on a given set of values).
ContextExpression—Represents a mechanism to retrieve context-specific information—e.g., retrieving the current index of iteration during the execution of a loop.
   “MapExpressions” are used to provide values that “MapStatements” and initialization constructs consume.

There can be some built-in functions for use with “FunctionInvocationExpression,” in order to provide some commonly used operations while performing transformations. Some of the operations defined can include:
StringConcatenate—Concatenates multiple input strings
StringFind—Finds a given string in another string and returns the index of the string being searched.
DateTimeReformat—Reformats a given date-time string according to a format specified by the user.
CumulativeSum—Computes the sum of a specified collection of integer values.
CumulativeConcatenate—Concatenates strings in a specified collection with an optional separator.
ListSelectValue—Selects a specific value of the first list member that matches a given predicate.
ListSelectUniqueGroups—Groups the items in a list by the specified members.
ListOrderBy—Orders the items in a list by the specified members.

“TextBasedExpressions” provide the ability to write expression text in a syntax similar to that of C#® arithmetic and logical expressions in order to enable users to easily perform such computations. For example, a user can write the expression “a+b*c” in a text based expression, define what “MapExpressions” correspond to “a,” “b,” and “c,” and compute the desired result during execution of a transform. “LambdaExpressions” provide the ability to write functions through text expressions that can be passed to other functions like “ListSelectValue” and “ListSelectEntries.”

Lists are provided to enable users to accumulate any intermediate data that may be needed to filter and transform data, and finally output data in a desired structure. One typical scenario in which lists might be used is where data in the input and output objects are pivoted on different axes. Lists can be used in such a scenario to collect a flat list of normalized data and produce the output based on the desired pivot.

Below is a pseudo code snippet that demonstrates a subset of list operations available in the exemplary intermediate language:

```
type Record_Type
{
    number Salary;
    number Bonus;
    string Id;
    string Name;
    string Category;
}
var $recordList =
[
    ForEach (var $emp in $srcRoot/Employees)
    {
        yield new Record_Type( )
        {
            Salary = $emp/Salary,
            Bonus = $emp/Bonus,
            Id = $emp/Id,
            Name = $emp/Name,
            Category = $emp/Category
        };
    }
];
// Examples for some operations on lists.
$val1 = $recordList.SelectValue($x => $x/Salary + $x/Bonus > 100000,
“Id”);
$recordList2 = $recordList.SelectEntries($x => $x/Salary + $x/Bonus >
100000, { “Id”, “Name” });
$listOfRecordLists = $recordList.GroupBy({ “Category” });
$recordList3 = $recordList.OrderBy({ “Salary”, “Bonus” });
MapEach ($rec2 in $recordList2 to $outputEmp in $tgtRoot/Employee)
{
    $outputEmp.Id = $rec2.Id;
    $outputEmp.Name = $rec2.Name;
}
```

As mentioned above, the IL assumes that it can deal with data in any format uniformly. This can be enabled by wrapping access to objects being operated on by the transformation through an interface. This interface can enable navigation of paths on objects participating in a transformation and population of objects via paths. For example, the following operations can be performed by the interface:
Given an object, get the sequence of nodes at a specified path.
Given an object, get the value at a specified path—for example, the value at a specified path can be the value wrapped in the first node in the sequence of nodes at the given path.
Given an object, get the value of a specific member.
Given an object, set the value at a specified path.
Given an object, set the value of a specified member.
Given an object, instantiate a collection at a specified path.
Given an object, add an item to a collection at a specified path.
Given an object, determine if an object exists at a specified path (this operation makes sense for formats like XML).
Given an object, determine if an object at a specified path is null.

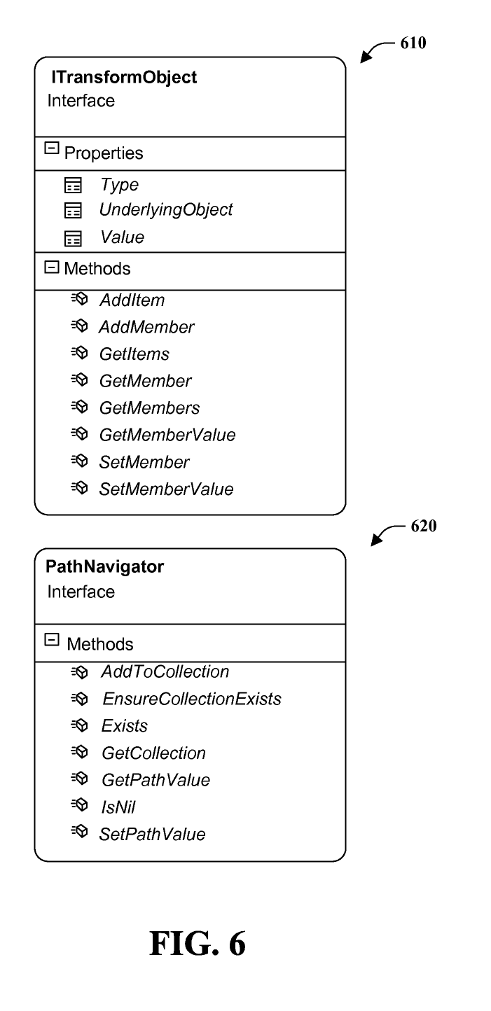

In accordance with one embodiment, two application programming interfaces can represent the object model utilized by the intermediate language. As shown in FIG. 6, the two interfaces can be “ITransformObject” 610 and “PathNavigator” 620.

The interface “ITransformObject” 610 is an abstraction of objects that the transform operates on during runtime. Of course, the transform's execution can also utilize common objects like integers and strings as well. The interface “ITransfromObject” 610 can represents objects of many kinds. For example, an object tree can be represented. In this case, the object can be visualized as the root of a tree with labeled edges pointing to child objects (e.g., the edge labels are member names). The methods “GetMember( )” “SetMember,” “GetMemberValue( ),” and “SetMemberValue( )” as well as the property “Value” can be used to access members of a given object or to obtain a value from a given “ITransformObject. Note that the description does not levy the restriction that edge-labels in the object tree, for a given object, have to be unique. It is possible that multiple members with the same name are present (e.g., in XML documents, repeating nodes can viewed this way). The method “GetMembers( )” enables retrieval of members with a given name. In cases of objects such as JSON arrays or CLR collections, a single object includes a collection of items. Getting and setting object contained in such collection objects is enabled by the methods “GetItems( )” and “AddItem( ).”

The interface “PathNavigator” 620 provides common object-navigation functionality based on paths that can be utilized by the IL. The methods “GetPathValue( )” and “SetPathValue( )” enable the IL to obtain values from input objects and to set values on output objects. The methods “GetCollection( ),” “EnsureCollectionExists( ),” and “AddToCollection( )” enable the IL to obtain collection of “ITransformObjects” from the named-values during transform execution, and to create and populate collection objects in the output objects as well. The methods “Exists( )” and “IsNil( )” are used to query the object tree as to whether objects exist at specified paths, and whether the objects at specified paths are nil.

The above-described or similar interfaces can be implemented for any data format. For example, interfaces can be implemented for XML documents, JSON objects, CLR objects, or EDI messages, among others.

Generated executable code can rely on a common object system as previously described. However, an alternate implementation is to produce format-specific code from an abstract syntax tree, for example, depending on the formats of the input and output objects. For example, if it is known that both the input and output objects use the XML format, XSLT can be generated from the abstract syntax tree and XSLT can be executed.

Yet another alternate implementation to a common object system can involve use an existing object system to wrap input data in other formats. In this manner, it is possible to generate executable code in a language specific to that object system to perform the transformation. For example, XPathNavigator and an information set can be employed. XPathNavigator is a mechanism that enables navigation of an information set (a.k.a. Infoset). An information set is an abstraction of the data model of an XML document that is expressed as a set of information items as nodes of a tree. Accordingly, interfaces can be employed on top of different data formats to view data as an information set. Subsequently, XPathNavigator in conjunction with XPath expressions can be utilized to perform data transformation.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the author component 110 can employ such functionality to infer functoids or maplets to suggest to a user based on context.

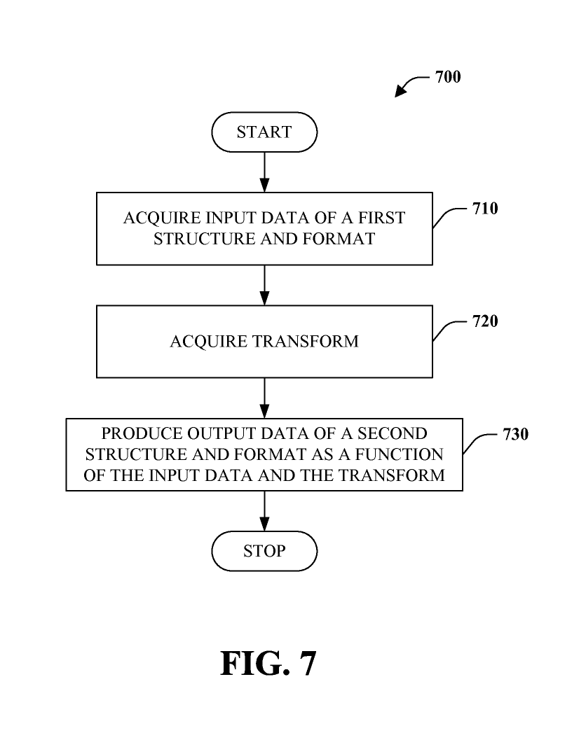

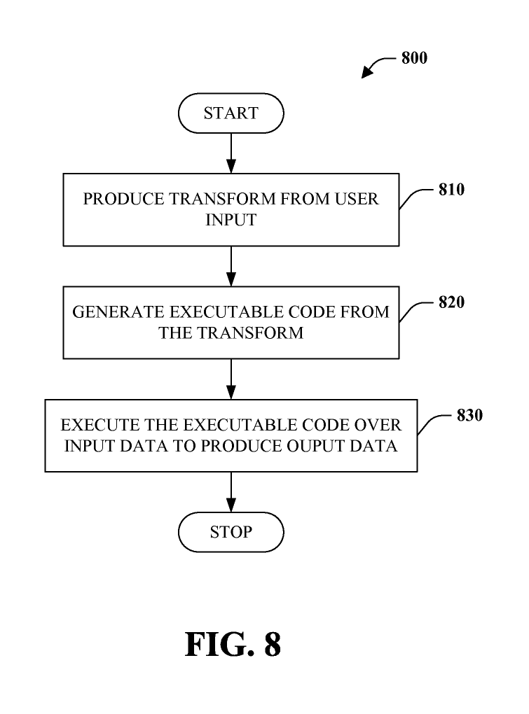

In view of the exemplary systems described supra, methodologies that may be implemented in accordance with the disclosed subject matter will be better appreciated with reference to the flow charts of FIGS. 7 and 8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a data transformation method 700 is illustrated. At reference numeral 710, input data of a first structure and format is received, retrieved, or otherwise obtained or acquired. Here, structure concerns the schema or organization of data. Format pertains to a serialization format such as, but not limited to, an XML document, a JSON object, or a CLR object. At numeral 720, a transform is received, retrieved or otherwise obtained or acquired. The transform maps input data of a first structure to output data of a second structure independent of actual or potential input or output data formats. In accordance with one aspect of the disclosure, a mapping component can be employed to allow a user to author the transform in a user-friendly manner, for example by interacting with a graphical interface. At reference numeral 730, output data of a second structure and format is produced as a function of the input data and the transform. Furthermore, the output data can be produced in any desired output data format.

FIG. 8 is a flow chart diagram of a method 800 of transforming data. At reference numeral 810, a transform is produced from user input. In one instance, the transform can encode a mapping between input data and output data specified by way of various gestures with respect to a graphical user interface provided by a mapping component. Additionally or alternatively, a map can be specified directly in in code of an underlying transformation language or in declarative programming language code that is subsequently converted to the underlying transformation language.

At numeral 820, computer-executable code is generated from the transform. Such generation can result from a compilation process, for example where links and functoids are read, an intermediate abstract syntax tree representation is created, syntactic and semantic analysis are performed with respect to the tree, and computer executable code is generated.

At reference numeral 830, the executable code is executed over input data to produce output data. During such execution, interfaces can be utilized to interact with different data formats. Where a common interface is employed, the interface is the same but the implementation of the interface is different to accommodate distinct data formats (CLR object, XML document . . . ). In other words, the set of interfaces differs based data format.

As described herein, interfaces have been disclosed as a mechanism for use in viewing data of different formats in a uniform or normalized manner. This has the benefit of not requiring conversion of an input document to a normalized form. Nevertheless, aspects of the claimed subject matter can be utilized in conjunction with conversion of an input document of an arbitrary first format to a normalized format and subsequently converting the normalized format to an arbitrary output format.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the terms “component,” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

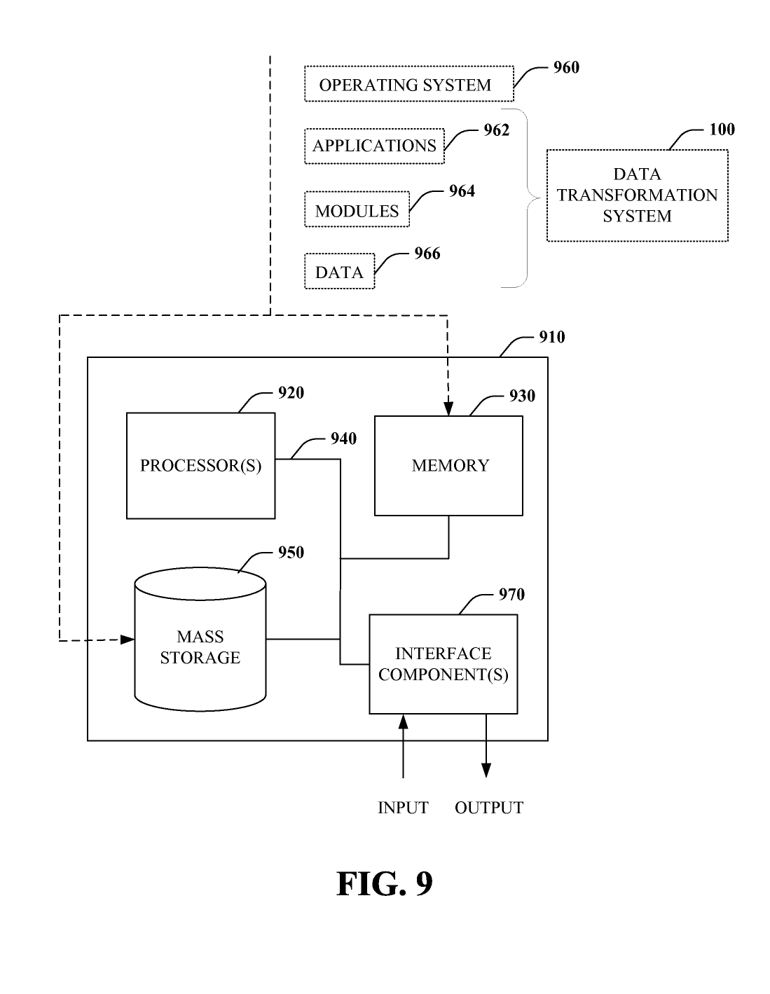

In order to provide a context for the claimed subject matter, FIG. 9 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer 910 or computing device (e.g., desktop, laptop, server, hand-held, programmable consumer or industrial electronics, set-top box, game system . . . ). The computer 910 includes one or more processor(s) 920, memory 930, system bus 940, mass storage 950, and one or more interface components 970. The system bus 940 communicatively couples at least the above system components. However, it is to be appreciated that in its simplest form the computer 910 can include one or more processors 920 coupled to memory 930 that execute various computer executable actions, instructions, and or components stored in memory 930.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 910 can include or otherwise interact with a variety of computer-readable media to facilitate control of the computer 910 to implement one or more aspects of the claimed subject matter. The computer-readable media can be any available media that can be accessed by the computer 910 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 910.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 910, such as during start-up, can be stored in nonvolatile memory, while volatile memory can act as external cache memory to facilitate processing by the processor(s) 920, among other things.

Mass storage 950 includes removable/non-removable, volatile/non-volatile computer storage media for storage of large amounts of data relative to the memory 930. For example, mass storage 950 includes, but is not limited to, one or more devices such as a magnetic or optical disk drive, floppy disk drive, flash memory, solid-state drive, or memory stick.

Memory 930 and mass storage 950 can include, or have stored therein, operating system 960, one or more applications 962, one or more program modules 964, and data 966. The operating system 960 acts to control and allocate resources of the computer 910. Applications 962 include one or both of system and application software and can exploit management of resources by the operating system 960 through program modules 964 and data 966 stored in memory 930 and/or mass storage 950 to perform one or more actions. Accordingly, applications 962 can turn a general-purpose computer 910 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the data transformation system 100, or portions thereof, can be, or form part, of an application 962, and include one or more modules 964 and data 966 stored in memory and/or mass storage 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the data transformation system 100 and/or associated functionality can be embedded within hardware in a SOC architecture.

The computer 910 also includes one or more interface components 970 that are communicatively coupled to the system bus 940 and facilitate interaction with the computer 910. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 910 through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., CRT, LCD, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A data transformation method, comprising:
employing at least one processor configured to execute computer-executable instructions stored in a memory to perform the following acts:
producing output data in a second format from input data in a first format as a function of a format-independent representation of a transformation that maps the input data of a first structure to the output data of a second structure.

2. The method of claim 1 further comprises generating the transformation from a graphical representation that expresses relations between the first structure and the second structure.

3. The method of claim 2, generating the transformation from the graphical representation including a loop structure that indicates performance of a specified transformation over a collection of elements of the input data.

4. The method of claim 2 further comprises generating the transformation as a function of a selected maplet.

5. The method of claim 4 further comprises automatically suggesting a maplet based on context.

6. The method of claim 1 further comprises saving a subset of the transformation as a re-usable maplet.

7. The method of claim 1 further comprises generating computer-executable code configured to produce the output data upon execution of the code based on the format-independent representation of the transformation.

8. The method of claim 1 further comprises generating the transformation as a function of code specified by way of a declarative programming language.

9. A data transformation system, comprising:
a processor coupled to a memory, the processor configured to execute the following computer-executable components stored in the memory:
a first component configured to generate output data from input data independent of format of the input data and the output data based on a transform that maps input data of a first structure to output data of a second structure.

10. The system of claim 9 further comprises a second component configured to generate the transform as a function of a graphical representation.

11. The system of claim 9 further comprises a second component configured to generate code, executable by the first component, as a function of the transform.

12. The system of claim 9, the transform is specified in an intermediate programming language.

13. The system of claim 9, the transform includes a loop structure that indicates performance of a specified transformation over at least a subset of the input data.

14. The system of claim 9 further comprises a second component configured to suggest a maplet based on context.

15. The system of claim 9 further comprises a second component configured to save at least a subset of the transform.

16. The system of claim 9, at least a portion of the transform is specified by way of a declarative programming language.

17. A computer-readable storage medium having stored thereon a set of application-programming interfaces for a data transformation application, comprising:
a first interface configured to represent, and enable interaction with, an input data structure subject to transformation independent of format of the input data structure and an output data structure.

18. The computer-readable storage medium of claim 17 further comprises a second interface configured to enable navigation of the input data structure.

19. The computer-readable storage medium of claim 18, the second interface is configured to obtain data from the input data structure as a function of an input data path.

20. The computer-readable storage medium of claim 19, the first interface is configured to assign data to the output data structure as a function of an output data path.
